(19) United States
(12) Patent Application Publication
(10) Pub. No.: US 2006/0043875 A1
(43) Pub. Date: Mar. 2, 2006

(54) Electron emission device and method of manufacturing the same

(76) Inventors: Chun-Gyoo Lee, Suwon-si (KR); Yong-Soo Choi, Suwon-si (KR); Byong-Gon Lee, Suwon-si (KR); Sang-Jo Lee, Suwon-si (KR)

Correspondence Address: CHRISTIE, PARKER & HALE, LLP, PO BOX 7068, PASADENA, CA, 91109-7068, US

(21) Appl. No.: 11/212,794

(22) Filed: Aug. 25, 2005

(30) Foreign Application Priority Data
Aug. 30, 2004 (KR) 10-2004-0068741

(51) Int. Cl. H01J 1/62

(52) U.S. Cl. 313/495; 313/497

(57) ABSTRACT

An electron emission device which increases the amount of electron emission without heightening the driving voltage for making the electron emission. The electron emission device includes a substrate, first electrodes formed on the substrate, electron emission regions electrically connected to the first electrodes, and second and third electrodes placed at planes different from the first electrodes. The second and the third electrodes receive the same voltage, and form the electric field for emitting electrons from the electron emission regions. Fourth electrodes may be placed at substantially the same plane as the first electrodes, and receive the same voltage as the second and the third electrodes.

### CROSS-REFERENCE TO RELATED APPLICATION

This application claims priority to and the benefit of Korean Patent Application No. 10-2004-0068741 filed on Aug. 30, 2004 in the Korean Intellectual Property Office, the entire content of which is incorporated herein by reference.

### BACKGROUND OF THE INVENTION

1. Field of the Invention

The present invention relates to an electron emission device, and in particular, to an electron emission device which has an improved electrode structure for emitting electrons from electron emission regions.

2. Description of Related Art

Generally, the electron emission devices are classified into a first type where a hot cathode is used as an electron emission source, and a second type where a cold cathode is used as the electron emission source. Among the second type of electron emission devices there are known: a field emitter array (FEA) type, a metal-insulator-metal (MIM) type, a metal-insulator-semiconductor (MIS) type, and a surface conduction emitter (SCE) type.

The MIM-type and the MIS-type electron emission devices have electron emission regions with a metal/insulator/metal (MIM) structure and a metal/insulator/semiconductor (MIS) structure, respectively. When voltages are applied to the two metals or the metal and the semiconductor on respective sides of the insulator, electrons supplied by the metal or semiconductor on the lower side pass through the insulator due to the tunneling effect and arrive at the metal on the upper side. Of the electrons that arrive at the metal on the upper side, those that have energy greater than or equal to the work function of the metal on the upper side, are emitted from the upper electrode.

The SCE electron emission device includes first and second electrodes formed on a substrate while facing each other, and a conductive thin film disposed between the first and the second electrodes. Micro-cracks are made at the conductive thin film to form electron regions. When voltages are applied to the electrodes while making the electric current flow to the surface of the conductive thin film, electrons are emitted from the electron regions.

The FEA electron emission device is based on the principle that when a material having a low work function or a high aspect ratio is used as an electron emission source, electrons are easily emitted from the material due to an electric field under a vacuum atmosphere. A sharp-pointed tip structure based on molybdenum or silicon, or a carbonaceous material such as carbon nanotubes, graphite, and diamond-like carbon, has been developed to be used as the electron emission source.

The cold cathode-based electron emission device has first and second substrates forming a vacuum region. Electron emission regions and electron emission electrodes for controlling the electron emission of the electron emission regions are formed on the first substrate. Phosphor layers and an electron accelerating electrode for making the electrons from the first substrate effectively accelerate toward the phosphor layers are formed on the second substrate, the phosphors thereby emitting light and displaying desired images.

The FEA electron emission device has a triode structure where cathode and gate electrodes are formed on the first substrate as the electron emission electrodes, and an anode electrode is formed on the second substrate as the electron accelerating electrode. The cathode and the gate electrodes are placed at different planes while receiving different voltages such that electrons are emitted from the electron emission regions electrically connected to the cathode electrodes.

With the FEA electron emission device, the amount of electron emission from the electron emission regions is exponentially increased with respect to the intensity E of the electric field formed around the electron emission regions. The intensity of the electric field may be proportional to the voltage applied to the gate electrodes.

However, with the currently available electron emission devices, the intensity of the electric field is not maximized due to the structural limitation of the gate electrodes so that the amount of electric current from the electron emission regions cannot be increased, and this makes it difficult to realize a high brightness display screen.

Of course, the voltage applied to the gate electrode may be increased to solve the above problem. However in such a case, it becomes difficult to make widespread usage of the electron emission device due to the increased power consumption, and with the use of a high cost driver, the production cost of the electron emission device is also increased.

### SUMMARY OF THE INVENTION

In accordance with the present invention, an electron emission device is provided that increases the amount of electron emission without increasing the driving voltage for making the electron emission.

According to one aspect of the present invention, the electron emission device includes a substrate, first electrodes formed on the substrate, and electron emission regions electrically connected to the first electrodes. Second and third electrodes are respectively placed at planes different from the first electrodes. The second and the third electrodes receive the same voltage to form the electric field for emitting electrons from the electron emission regions

Fourth electrodes may be placed at substantially the same plane as the first electrodes while receiving the same voltage as the second and the third electrodes. In this case, a first insulating layer is disposed between the second and the fourth electrodes, and the fourth electrodes contact the second electrodes through via holes formed at the first insulating layer.

The first electrodes are disposed between the second and the third electrodes, and the second electrodes are placed closer to the substrate than the third electrodes.

At least one group of the second and the third electrodes has a plurality of electrodes arranged on the substrate with a distance therebetween while being stripe-patterned in a direction of the substrate.

According to another aspect of the present invention, the electron emission device includes a substrate, cathode electrodes formed on the substrate, and electron emission regions electrically connected to the cathode electrodes. A plurality of gate electrodes are placed at planes different from the cathode electrodes while receiving the same voltage to form the electric field for emitting electrons from the electron emission regions.

The gate electrodes include first gate electrodes placed under the cathode electrodes with a first insulating layer interposed between the first gate electrodes and the cathode electrodes, and second gate electrodes placed over the cathode electrodes with a second insulating layer interposed between the second gate electrodes and the cathode electrodes. The end portions of the first and the second gate electrodes contact each other while making an electrical connection.

The electron emission device may further include counter electrodes placed at substantially the same plane as the cathode electrodes while contacting the first electrodes through via holes formed at the first insulating layer.

According to still another aspect of the present invention, the electron emission device includes a substrate, scanning electrodes formed on the substrate, and electron emission regions electrically connected to the scanning electrodes. A plurality of data electrodes are placed at planes different from the scanning electrodes while receiving the same voltage to form the electric field for emitting electrons from the electron emission regions.

According to still another aspect of the present invention, the electron emission device includes a substrate, electron emission regions formed on the substrate and receiving a predetermined electric potential, and electron emission electrodes sandwiched around the electron emission regions.

The electron emission electrodes include cathode electrodes electrically connected to the electron emission regions, and a plurality of gate electrodes placed at planes different from the cathode electrodes and receiving the same voltage to form the electric field for emitting electrons from the electron emission regions.

In a method of manufacturing the electron emission device, first gate electrodes are formed on a substrate. A first insulating layer is formed on the entire surface of the substrate while covering the first gate electrodes. The first insulating layer is partially etched to form via holes. A conductive layer is formed on the first insulating layer, and is patterned to form cathode electrodes and counter electrodes contacting the first gate electrodes through the via holes. A second insulating layer is formed on the cathode electrodes, the counter electrodes, and the first insulating layer. The second insulating layer has an etch rate different from the etch rate of the first insulating layer. A conductive layer is formed on the second insulating layer, and is patterned to form second gate electrodes with opening portions. The second insulating layer exposed through the opening portions is partially etched to form opening portions thereat.

### BRIEF DESCRIPTION OF THE DRAWINGS

FIG. 1 is a partial exploded perspective view of an electron emission device according to an embodiment of the present invention.

FIG. 2 is a partial sectional view of the electron emission device according to an embodiment of the present invention.

FIG. 3 is a partial perspective view of first and second gate electrodes of the electron emission device according to an embodiment of the present invention.

FIG. 4 is a graph illustrating the average current (la) characteristic pursuant to the voltage difference Vcg between the cathode and the gate electrodes.

FIGS. 5A, 5B, 5C, 5D and 5E schematically illustrate the steps of processing the electron emission device according to an embodiment of the present invention.

### DETAILED DESCRIPTION

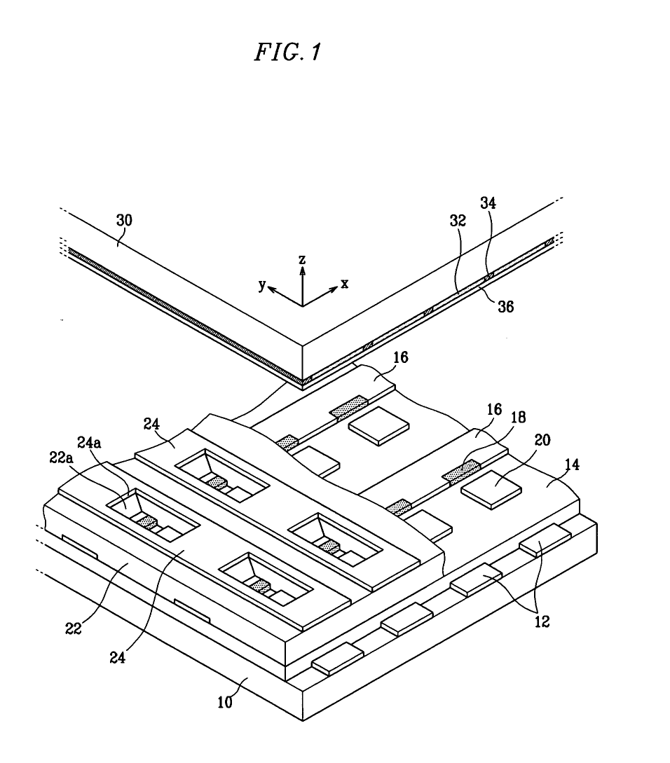

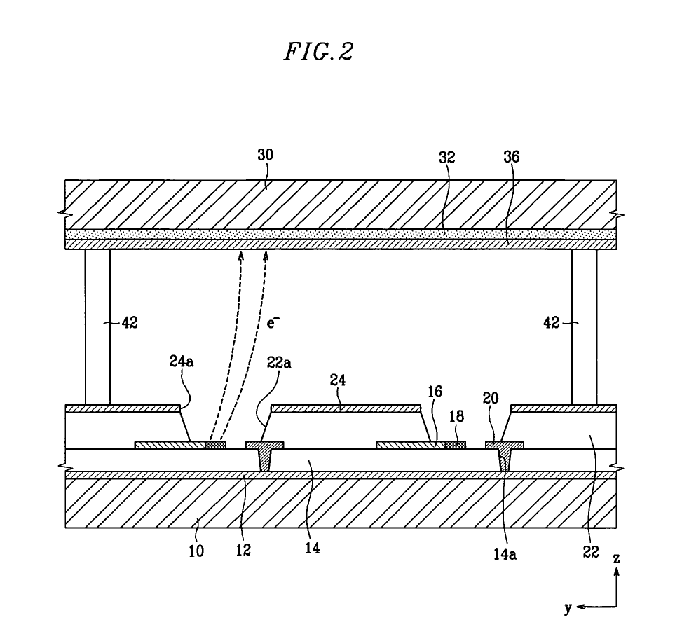

Referring now to FIGS. 1 and 2, the electron emission device includes first and second substrates 10, 30 arranged substantially parallel to each other with a predetermined distance therebetween, and sealed to each other to form a vacuum region outlining the electron emission device. An electron emission structure is formed at the first substrate 10, and a light emission structure is formed at the second substrate 30 to emit visible rays and to display desired images as a result of emitted electrons striking the light emission structure.

Cathode electrodes 16 and first gate electrodes 12 are formed on the first substrate 10 as first and second electrodes respectively, with a first insulating layer 14 interposed therebetween. The first gate electrodes 12 are positioned closer to the first substrate 10 as compared to the cathode electrodes 16.

The cathode electrodes 16 are formed at the first substrate 10 in a plural manner and stripe-patterned in a direction thereof (e.g., in the direction of an x axis). The first insulating layer 14 is formed over the entire surface of the first substrate 10 while covering the first gate electrodes 12. The first gate electrodes 12 are arranged at the first substrate 10 at a predetermined distance therebetween in a plural manner and stripe-patterned in the direction crossing the cathode electrodes 16 (e.g., in the direction of a y axis).

Electron emission regions 18 partially contact the cathode electrodes 16 such that they are electrically connected to the cathode electrodes 16. The electron emission regions 18 are arranged corresponding to the pixel regions defined on the first substrate 10. In this embodiment, the pixel regions are defined as the crossed-regions of the first gate electrodes 12 and the cathode electrodes 16. As shown in the drawings, the electron emission regions 18 are formed at one side of the peripheries of the cathode electrodes 16 corresponding to the respective pixel regions, such that at least one lateral side thereof contacts the cathode electrode 16.

In this embodiment, the electron emission regions 18 are formed with a material capable of emitting electrons under the application of an electric field, such as a carbonaceous material, and a nanometer-sized material. Various embodiments of the electron emission regions 18 may be formed with carbon nanotubes, graphite, graphite nanofiber, diamond, diamond-like carbon, C₆₀, silicon nanowire, or a combination thereof, by way of screen-printing, chemical vapor deposition, direct growth, or sputtering.

A second insulating layer 22 is formed over the cathode electrodes 16 and the first insulating layer 14, and second gate electrodes 24 are formed on the second insulating layer 22 as third electrodes. The second insulating layer 22 and the second gate electrodes 24 have opening portions 22a, 24a exposing electron emission regions 18, respectively. As shown in FIG. 1, the second gate electrodes 24 are stripe-patterned in a direction of the first substrate 10 (in the direction of the y axis).

The second gate electrodes 24 are electrically connected to the first gate electrodes 12 while receiving the same voltage, and cause formation of an electric field for emitting electrons from the electron emission regions 18 together with the first gate electrodes 12. In an exemplary embodiment the second gate electrodes 24 are arranged substantially parallel to the first gate electrodes 12 in one-to-one correspondence thereto.

Counter electrodes 20 are formed on the first substrate 10 as fourth electrodes to pull up the electric field of the first gate electrodes 12 to the first insulating layer 14. The counter electrodes 20 are spaced apart from the electron emission regions 18 between the cathode electrodes 16, and contact the first gate electrodes 12 through via holes 14a formed at the first insulating layer 14 while being electrically connected thereto. As with the electron emission regions 18, the counter electrode 20 may be provided corresponding to a respective pixel region defined on the first substrate 10. The counter electrodes 20 are partially placed on the first insulating layer 14 while standing substantially in the same plane as the cathode electrodes 16.

The opening portions 22a, 24a of the second insulating layer 22 and the second gate electrodes 24 correspond to the pixel regions defined on the first substrate 10, and may partially or wholly expose the counter electrodes 20 together with the electron emission regions 18. Although the opening portions 22a, 24a of the second insulating layer 22 and the second gate electrodes 24 are illustrated in the drawings as having a rectangular planar shape, the rectangular planar shape and the number of the opening portions 22a, 24a are not limited thereto, but can be altered in various manners.

As the second gate electrode 24 comes closer to the electron emission regions 18, the intensity of the electric field applied to the electron emission regions 18 becomes increased. In one embodiment the opening portions 22a, 24a formed at the second insulating layer 22 and the second gate electrodes 24 could be as small as possible. For instance, the opening portions 22a, 24a of the second insulating layer 22 and the second gate electrodes 24 would partially expose the counter electrodes 20 facing the electron emission regions 18, while placing the electron emission regions 18 at the center thereof.

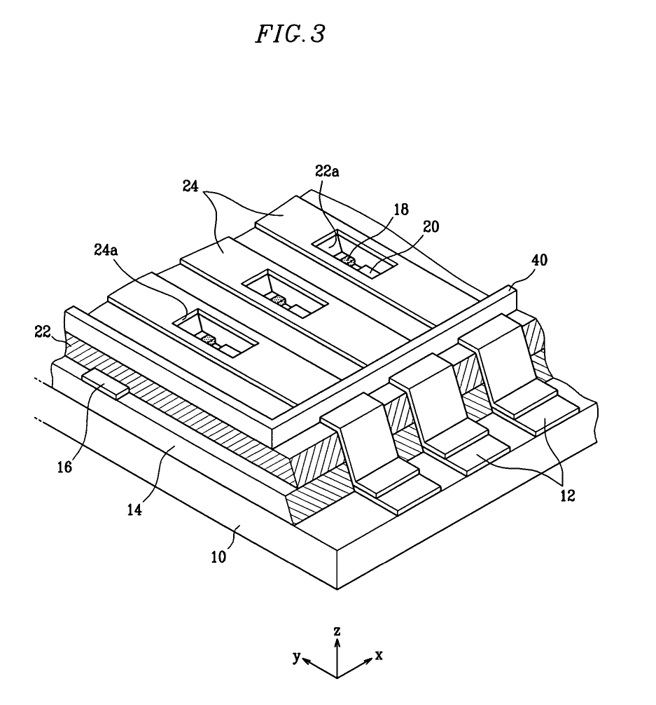

The respective second gate electrodes 24 are electrically connected to the corresponding first gate electrodes 12, and the connection structure is illustrated in FIG. 3, which is a partial perspective view of the electron emission device, illustrating the end portions of the first and the second gate electrodes. As shown in FIG. 3, the end portion of the first gate electrode 12 is exposed to the outside of the first and the second insulating layers 14, 22, and the end portion of the second gate electrode 24 is extended over the lateral sides of the second insulating layer 22 and the first insulating layer 14 and the top surface of the first gate electrode 12, and contacts the first gate electrode 12, making electrical connection thereto.

As described above, electron emission regions 18 and electron emission electrodes for controlling the electron emission of the electron emission regions 18 are placed on the first substrate 10. In this embodiment, the electron emission electrodes include the first and the second gate electrodes 12, 24 placed at the top and the bottom of the cathode electrodes 16, and the counter electrodes 20 placed at substantially the same plane as the cathode electrodes 16. The first and the second gate electrodes 12, 24 and the counter electrodes 20 are placed in the form of a sandwich to simultaneously form the electric fields required for the top, the bottom, and the lateral sides of the electron emission regions 18.

The first and the second insulating layers 14, 22 for insulating the electrodes may be formed with different materials, and more specifically, materials having different etch rates with respect to an etching solution or gas. The difference in the etch rates prevents the deformation of the first insulating layer 14 due to etching thereof when the second insulating layer 22 is partially etched to form opening portions 22a. In relation to the same etching solution or gas, in one embodiment the etch rate of the first insulating layer 14 may be established to be ⅓ or less that of the second insulating layer 22.

Furthermore, the second insulating layer 22 and the cathode electrodes 16 may also be formed with materials differentiated in etch rate related to an etching solution or gas. This also prevents the deformation of the cathode electrodes 16 due to etching thereof when the second insulating layer 22 is partially etched to form the opening portions 22a. In relation to the same etching solution or gas, in one embodiment the etch rate of the cathode electrodes 16 may be established to be 1/10 or less that of the second insulating layer 22.

For instance, when the second insulating layer 22 is etched using an etching solution containing hydrogen fluoride (HF) to thereby form the opening portions 22a, the cathode electrodes 16 may be formed with a material satisfying the above etch rate condition, such as aluminum (Al), chromium (Cr), and molybdenum (Mo).

As with the cathode electrodes 16, the counter electrodes 20 are also partially exposed through the opening portions 22a of the second insulating layer 22. In order to prevent the deformation of the counter electrodes 20 during the patterning process of the second insulating layer 22, the counter electrodes 20 may be formed with a material satisfying the same etch rate condition as the cathode electrodes 16 with respect to the etching solution or gas for the second insulating layer 22. In one embodiment the counter electrodes 20 would be formed with the same material as that for the cathode electrodes 16.

Referring back to FIGS. 1 and 2, red, green, and blue phosphor layers 32 are arranged on the surface of the second substrate 30 facing the first substrate 10 at a predetermined distance therebetween. Black layers 34 are disposed between the phosphor layers 32 to enhance the screen contrast. An anode electrode 36 is formed on the phosphor layers 32 and the black layers 34 through depositing a metallic layer (for instance, an aluminum layer). The anode electrode 36 receives a voltage required for accelerating the electron beams from the outside, and has the role of increasing the screen brightness by way of a metal back effect.

The anode electrode may be formed with a transparent conductive material, such as indium tin oxide (ITO), rather than a metallic material. In this case, an anode electrode (not shown) is formed on the second substrate 30 with the transparent conductive material, and then, phosphor layers 32 and black layers 34 are formed on the anode electrode. When needed, a metallic layer is formed on the phosphor layers 32 and the black layers 34 to enhance the screen brightness. The anode electrode may be formed over the entire surface of the second substrate 30, or partitioned into plural portions with a predetermined pattern.

The above-structured first and second substrates 10, 30 are sealed to each other via a frit-like sealing member 40 shown in FIG. 3 such that the second gate electrodes 24 face the anode electrode 36 at a predetermined distance therebetween, and the inner space between the substrates 10, 30 is exhausted to be in a vacuum state, thereby making an electron emission device. A plurality of spacers 42 shown in FIG. 2 are arranged at the non-light emission area between the first and the second substrates 10, 30 to maintain a constant distance between the substrates 10, 30.

With the above-structured electron emission device, when a predetermined voltage is applied to the cathode and the first gate electrodes 16, 12, the same driving voltage is also applied to the second gate electrode 24 and the counter electrode 20 since they are electrically connected to the first gate electrode 12. For instance, a negative (−) scanning voltage of several to several tens of volts is applied to the cathode electrode 16, and a positive (+) data voltage of several to several tens of volts is applied to the first gate electrode 12 such that the cathode electrodes 16 are used as scanning electrodes, and the first and second gate electrodes 12, 24 are used as data electrodes. The numerical values of the scanning voltage and the data voltage are not limited to the above, but may be changed as needed to accommodate the desired electron emission.

An electric field is formed at the bottom of the electron emission region 18 due to the potential difference between the cathode and the first gate electrodes to emit electrons, and another electric field is formed at the lateral side of the electron emission region 18 due to the potential difference between the cathode and the counter electrodes 16, 20. Still another electric field is formed at the top of the electron emission regions 18 due to the potential difference between the cathode and the second gate electrodes 16, 24.

The emitted electrons are attracted by the high voltage applied to the anode electrode 36, and proceed toward the second substrate 30, thereby landing on the phosphor layers 32 at the relevant pixels and exciting them.

According to the Fowler-Nordheim equation expressing the relation between the electric field applied to the electron emission regions 18 and the amount of electron emission, the electron emission is exponentially increased with respect to the intensity of the electric field E. When it is assumed that the cathode voltage is 0V and the electron emitting effect due to the anode voltage is weak, the relation between the intensity of the electric field E applied to the electron emission regions 18 and the gate voltage Vg is expressed by the following formula:
E=β1×Vg+β2×Vg+β3×Vg
where β1 is the proportional constant based on the first gate electrode 12, β2 is the proportional constant based on the counter electrode 20, and β3 is the proportional constant based on the second gate electrode 24.

As described above, with the electron emission device according to the embodiment of the present invention, three electrodes provide for the formation of the electric fields required for the electron emission, utilizing the potential difference thereof from the cathode electrode 16. The three electrodes are placed at different planes to simultaneously form the electric fields at the top, the bottom, and the lateral sides of the electron emission regions 18. Accordingly, the electron emission device according to the present embodiment maximizes the intensity of the electric fields applied to the electron emission region 18 when using the same gate voltage Vg as with the conventional electron emission device. Consequently, the amount of electron emission is increased without increasing the driving voltage.

In particular, the rate increase of electron emission is in proportion to the proportional constant β3 based on the second gate electrode 24. The value of β3 is typically increased as the second gate electrode 24 comes closer to the electron emission regions 18. In this situation, as described earlier, the second insulating layer 22 and the second gate electrode 24 are structured to maximize the rate increase of electron emission by reducing the size of the opening portions 22a, 24a as much as possible.

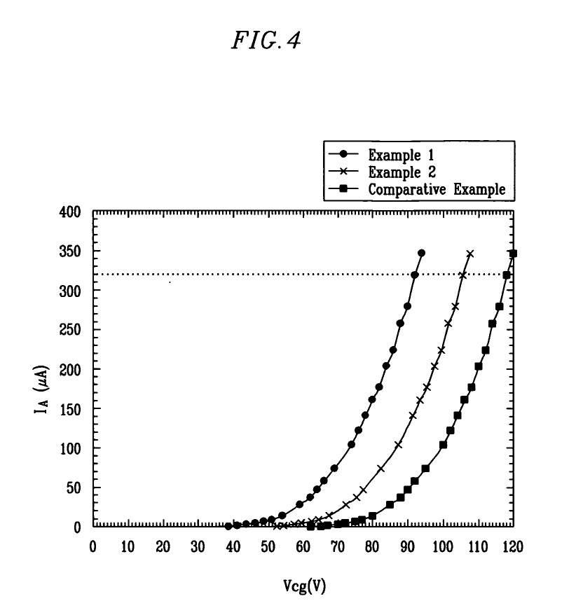

FIG. 4 is a graph illustrating the average current characteristic I_{A} pursuant to the voltage difference between the cathode and the gate electrodes V_{cg}. The curves indicate the electron emission made under a relevant voltage condition for Examples 1 and 2 and a Comparative Example, respectively. For the electron emission device under test, the anode voltage is 700V and the distance between the electron emission region and the counter electrode is about 30 μm.

Example 1 relates to the case where opening portions 24a with the size of 40×90 μm are arranged at the second gate electrodes 24 in the direction of x and y axes thereof. Example 2 relates to the case where opening portions 24a with the size of 100×120 μm are arranged at the second gate electrodes 24 in the direction of x and y axes thereof. The Comparative Example relates to the case where the second insulating layer and the second gate electrode are omitted.

As can be seen in FIG. 4, as the opening portions 24a formed at the second gate electrodes 24 become smaller, the amount of electron emission is increased. The driving voltage for achieving the desired electron emission with Example 1 is relatively small, as compared to Example 2 and the Comparative Example. Accordingly, the electron emission device according to the present embodiment significantly increases the amount of electron emission without increasing the driving voltage. This results in decreased power consumption, and reduced production cost since a high cost driver need not be introduced.

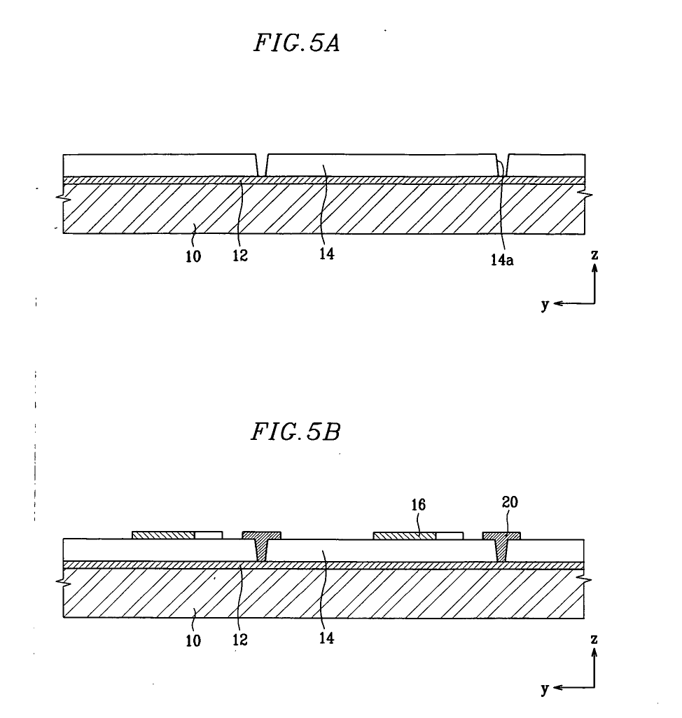

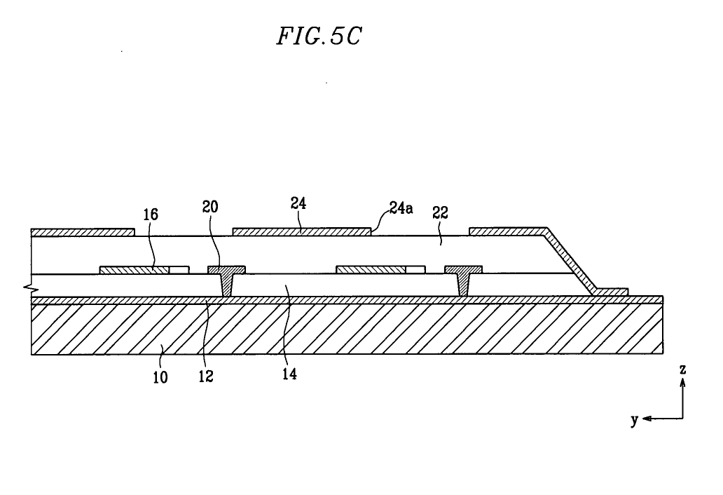

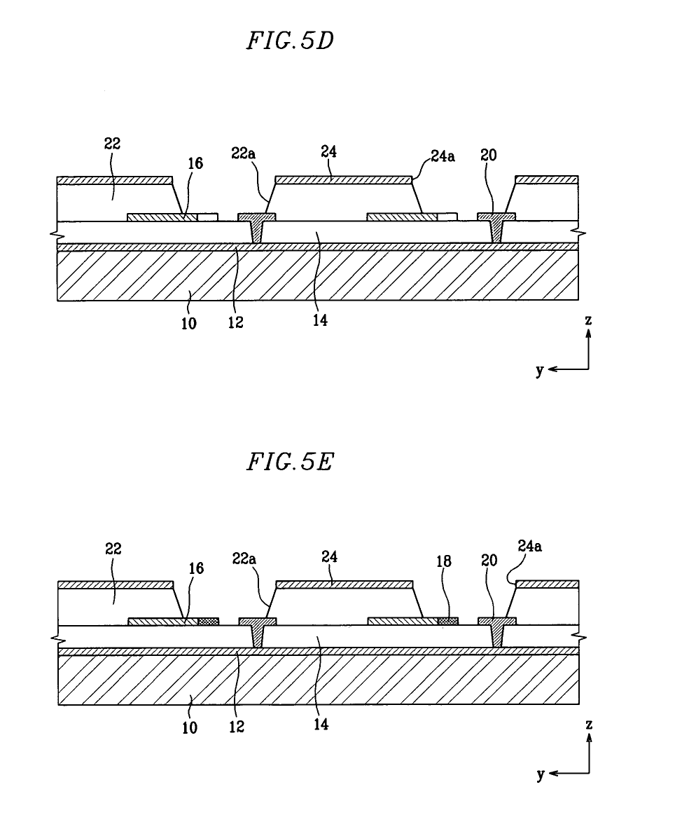

A method of manufacturing the electron emission device in accordance with the present invention will be now explained with reference to FIGS. 5A to 5E.

As shown in FIG. 5A, first gate electrodes 12 are stripe-patterned on the first substrate 10 in a direction of the first substrate 10, and a first insulating layer 14 is formed over the entire surface of the first substrate 10 while covering the first gate electrodes 12. The first insulating layer 14 may be repeatedly screen-printed. In order to form counter electrodes, a photoresist (not shown) is patterned on the first insulating layer 14, and the first insulating layer 14 is partially etched through the photoresist pattern to thereby form via holes 14a. The photoresist pattern is then removed.

Thereafter, as shown in FIG. 5B, a conductive layer is formed on the first insulating layer 14, and is patterned to thereby form cathode electrodes 16 and counter electrodes 20. In consideration of the etching and the firing process of the second insulating layer, the cathode electrodes 16 and the counter electrodes 20 are formed with a material having an etch rate of 1/10 or less of that of the second insulating layer, while being oxidized or thermally deteriorated minimally. For instance, the cathode electrodes 16 and the counter electrodes 20 are formed with aluminum (Al), chrome (Cr), or molybdenum (Mo).

Thereafter, as shown in FIG. 5C, a second insulating layer 22 is formed on the first insulating layer 14 and overlaying the cathode electrodes 16 and the counter electrodes 20. The second insulating layer 22 is formed with an insulating material largely differentiated from the first insulating layer 14 in etch rate. In one embodiment a material has an etch rate with respect to an etching solution or gas three times greater than that of the first insulating layer 14.

A conductive layer is formed on the second insulating layer 22, and is patterned to form stripe-shaped second gate electrodes 24 with internal opening portions 24a. At this time, first and second insulating layers 14, 22 are formed such that the end portion of each first gate electrode 12 is exposed to the outside of the first and the second insulating layers 14, 22, and the second gate electrodes 24 are formed such that the end portion of each second gate electrode 24 is placed on the lateral side of the first and second insulating layers 14, 22 as well as on the top surface of the first gate electrode 12. In this way, the two gate electrodes 12, 24 are electrically connected to each other.

Thereafter, as shown in FIG. 5D, the second insulating layer 22 is partially etched using an etching solution or gas to thereby form opening portions 22a. For example, an etching solution containing hydrogen fluoride (HF) may be used in forming the opening portions 22a. As the etch rate of the first insulating layer 14 with respect to the etching solution for the second insulating layer 22 is ⅓ or less of that of the second insulating layer 22, the possible damage to the first insulating layer made during the formation of the opening portions 22a of the second insulating layer can be minimized.

As shown in FIG. 5E, an electron emitting material is then deposited onto one side of peripheries of the cathode electrodes 16 to thereby form electron emission regions 18. The electron emitting material may include carbon nanotubes, graphite, graphite nanofiber, diamond, diamond-like carbon, C₆₀, silicon nanowire, and combinations thereof.

When the electron emission regions 18 are formed, an organic material such as a vehicle and a binder is mixed with the electron emitting material to form a paste with a viscosity adequate for printing. The paste is screen-printed, dried, and fired. A photosensitive material is added to the paste, and the photosensitive paste is screen-printed onto the entire surface of the first substrate 10. A photomask (not shown) is placed over the paste film, and the film is partially exposed to light to be partially hardened, and developed.

The completed first substrate 10 is assembled with the second substrate 30 having the phosphor layers 32, the black layers 34, and the anode electrode 36, and internally exhausted to thereby make an electron emission device. The specific explanation for the steps of forming the phosphor layers 32, the black layers 34, and the anode electrode 36 on the second substrate 30 as well as the steps of assembling the two substrates 10, 30 are known in the art and will be omitted herein.

As described above, the amount of electron emission is significantly increased without needing to increase the driving voltage. Consequently, with the inventive electron emission device, the screen brightness and the color representation are enhanced, and the power consumption is reduced. Furthermore, as a high cost driver need not be introduced, the production cost is lowered. The inventive electron emission device is not limited to the FEA type, but may be altered in various manners.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

What is claimed is:

1. An electron emission device comprising:
a substrate;
first electrodes formed on the substrate;
electron emission regions electrically connected to the first electrodes; and
second electrodes and third electrodes respectively placed at planes different from the first electrodes, the second electrodes and the third electrodes receiving the same voltage and adapted to form an electric field for emitting electrons from the electron emission regions.

2. The electron emission device of claim 1, further comprising fourth electrodes placed at substantially the same plane as the first electrodes and receiving the same voltage as the second electrodes and the third electrodes.

3. The electron emission device of claim 2, wherein a first insulating layer is disposed between the second electrodes and the fourth electrodes, and the fourth electrodes contact the second electrodes through via holes formed at the first insulating layer.

4. The electron emission device of claim 1, wherein the first electrodes are disposed between the second electrodes and the third electrodes, and the second electrodes are positioned closer to the substrate as compared to the third electrodes.

5. The electron emission device of claim 4, wherein at least one group of the second electrodes and the third electrodes has a plurality of electrodes arranged on the substrate at a predetermined distance therebetween while being stripe-patterned in a direction of the substrate.

6. The electron emission device of claim 4, wherein both groups of the second electrodes and the third electrodes have a plurality of electrodes arranged on the substrate at a predetermined distance therebetween while being stripe-patterned in a direction of the substrate.

7. An electron emission device comprising:
a substrate;
cathode electrodes formed on the substrate;
electron emission regions electrically connected to the cathode electrodes; and
a plurality of gate electrodes placed at planes different from the cathode electrodes and receiving the same voltage to form an electric field for emitting electrons from the electron emission regions.

8. The electron emission device of claim 7, wherein the plurality of gate electrodes comprise first gate electrodes placed under the cathode electrodes with a first insulating layer interposed between the first gate electrodes and the cathode electrodes, and second gate electrodes placed over the cathode electrodes with a second insulating layer interposed between the second gate electrodes and the cathode electrodes.

9. The electron emission device of claim 8, wherein the first gate electrodes and the second gate electrodes have a respective plurality of electrodes arranged on the substrate with a distance therebetween while being stripe-patterned in a direction of the substrate.

10. The electron emission device of claim 9, wherein respective first gate electrode end portions and second gate electrode end portions make electrical connection with each other.

11. The electron emission device of claim 8, further comprising counter electrodes placed at substantially the same plane as the cathode electrodes and contacting the first electrodes through via holes formed at the first insulating layer.

12. An electron emission device comprising:
a substrate;
scanning electrodes formed on the substrate;
electron emission regions electrically connected to the scanning electrodes; and
a plurality of data electrodes placed at planes different from the scanning electrodes and receiving the same voltage to form an electric field for emitting electrons from the electron emission regions.

13. The electron emission device of claim 12, wherein the plurality of data electrodes comprise first data electrodes placed under the scanning electrodes with a first insulating layer interposed between the first data electrodes and the scanning electrodes, and second data electrodes placed over the scanning electrodes with a second insulating layer interposed between the second data electrodes and the scanning electrodes.

14. The electron emission device of claim 13, wherein the first data electrodes and the second data electrodes have a plurality of electrodes arranged on the substrate at a predetermined distance therebetween while being stripe-patterned in a direction of the substrate.

15. The electron emission device of claim 14, wherein respective first data electrode end portions and second data electrode end portions make electrical connection with each other.

16. The electron emission device of claim 13, further comprising third data electrodes placed at substantially the same plane as the scanning electrodes and contacting the first data electrodes through via holes formed at the first insulating layer.

17. An electron emission device comprising:
a substrate;
electron emission regions formed on the substrate and receiving a predetermined electric potential; and
electron emission electrodes sandwiched around the electron emission regions.

18. The electron emission device of claim 17, wherein the electron emission electrodes comprise cathode electrodes electrically connected to the electron emission regions, and a plurality of gate electrodes placed at planes different from the cathode electrodes and receiving the same voltage to form an electric field for emitting electrons from the electron emission regions.

19. The electron emission device of claim 18, wherein the plurality of gate electrodes comprise first gate electrodes placed under the cathode electrodes with a first insulating layer interposed between the first gate electrodes and the cathode electrodes, and second gate electrodes placed over the cathode electrodes with a second insulating layer interposed between the second gate electrodes and the cathode electrodes.

20. The electron emission device of claim 19, further comprising counter electrodes placed at substantially the same plane as the cathode electrodes and contacting the first electrodes through via holes formed at the first insulating layer.

21. The electron emission device of claim 7, wherein the electron emission regions are formed with at least one material selected from the group consisting of carbon nanotubes, graphite, graphite nanofiber, diamond, diamond-like carbon, C₆₀, and silicon nanowire.

22. The electron emission device of claim 7, further comprising an anode electrode formed at a counter substrate facing the substrate with a predetermined distance therebetween, and phosphor layers formed on the anode electrode.

23. The electron emission device of claim 8, wherein the first insulating layer and the second insulating layer have etch rates different from each other.

24. The electron emission device of claim 23, wherein the etch rate of the first insulating layer is ⅓ or less of the etch rate of the second insulating layer.

25. A method of manufacturing an electron emission device comprising:
forming first gate electrodes on a substrate;
forming a first insulating layer over the entire surface of the substrate while covering the first gate electrodes, and partially etching the first insulating layer to form via holes;
forming a conductive layer on the first insulating layer, and patterning the conductive layer to form cathode electrodes, and counter electrodes contacting the first gate electrodes through the via holes;
forming a second insulating layer on the cathode electrodes, the counter electrodes and the first insulating layer, the second insulating layer having an etch rate different from the etch rate of the first insulating layer;
forming a conductive layer on the second insulating layer, and patterning the conductive layer to form second gate electrodes with opening portions; and
partially etching the second insulating layer exposed through the opening portions to form opening portions at the second insulating layer.

26. The method of claim 25, wherein when the first insulating layer and the second insulating layer are formed, the first insulating layer is formed with a material having an etch rate being ⅓ or less of the etch rate of the second insulating layer.

27. The method of claim 25, wherein when the second gate electrodes are formed, the second gate electrodes are arranged parallel to the first gate electrodes in a one-to-one correspondence thereto.

28. The method of claim 25, wherein when the first insulating layer and and the second insulating layer are formed, first gate electrode end portions are exposed to the outside, and when the second gate electrodes are formed, second gate electrode end portions contact the lateral sides of the first insulating layer and the second insulating layer as well as the top surfaces of the first gate electrodes.

29. The method of claim 25, further comprising forming electron emission regions at the exposed portions of the cathode electrodes after the opening portions are formed at the second insulating layer.

30. The method of claim 29, wherein forming electron emission regions comprises
making a paste-phased electron emitting material by mixing an organic material with at least one material selected from the group consisting of carbon nanotubes, graphite, graphite nanofiber, diamond, diamond-like carbon, C₆₀, and silicon nanowire; and
screen-printing, drying, and firing the electron emitting material.
